(19) United States
(12) Patent Application Publication
(10) Pub. No.: US 2002/0158164 A1
(43) Pub. Date: Oct. 31, 2002

(54) Cockpit for light airplanes

(76) Inventor: Helmut Konig, Graz (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/084,760

(22) Filed: Feb. 22, 2002

(30) Foreign Application Priority Data
Mar. 2, 2001 (DE) 10110137.6

(51) Int. Cl. B64C 1/00

(52) U.S. Cl. 244/1 R

(57) ABSTRACT

An instrument panel for use in light airplanes, particularly gliders and motorized gliders with small fuselage cross-sections and a cockpit which has little space available for the instrument panel. The instrument panel has at least one display (2) and several function keys (6) for selecting what is to be shown on the display, and indicators (7) which are associated with the individual function keys. The outer boundary of at least one side of the display, the function keys and the indicators is arcuate so that it follows the shape of the available space to thereby provide unobstructed sight to the outside from the cockpit.

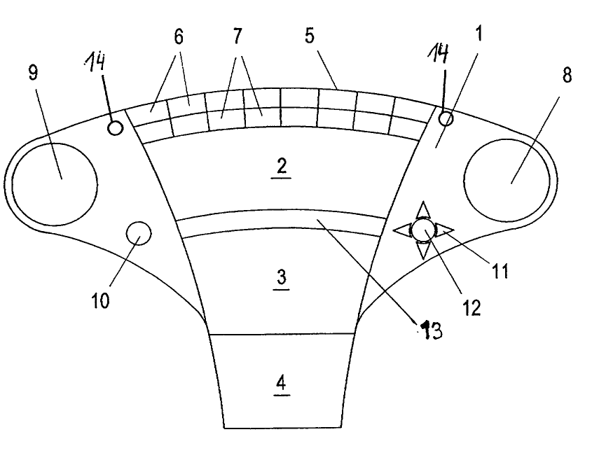

### BACKGROUND OF THE INVENTION

The invention concerns cockpits for light airplanes, particularly for gliders and motorized gliders, which have instrument panels and navigational instruments arranged thereon.

To maintain low air resistance, the cross-section of the fuselage of light airplanes, particularly the forward portion thereof, must be as small as possible. As a result, there is only limited space for the instrument panel and the navigational instruments arranged thereon. The need for instruments for regulating and controlling the various systems that are found on modern light airplanes increases as such systems increase in number and sophistication.

In the past, light airplanes carried circular or square-shaped instruments of standardized dimensions. The instruments were arranged side-by-side on the instrument panel, which limited the number of instruments that could be arranged on the panel since the panel necessarily includes unusable surface portions, including surface areas between the instruments. As a result, the surface area of the instrument panel relative to the instruments arranged thereon is disproportionately large, which negatively affects the sight from the cockpit.

In addition, such subsystems are not needed continuously over the entire flight but only through certain phases thereof. For example, in a circular, thermal flight a variometer is necessary, while for fast, long distance flights speed information is of interest.

### SUMMARY OF THE INVENTION

It is an object of the present invention to provide a cockpit for light airplanes which houses all instruments needed for navigation in spite of the limited available space, while nevertheless maintaining the surface area of the instrument panel sufficiently small so that the sight from the cockpit is not compromised. The present invention therefore proposes to provide an instrument panel which carries at least one display and several function keys or switches, which preferably have associated indicators, for selecting what is being displayed. The outer boundary or periphery of the display, function keys and indicators has at least one side which is arcuate. The function keys serve for activating the desired functions, while the indicators associated with the function keys provide a continuing display of a primary reference value for the function in question. The functions relevant to the state of the flight—instrument symbols—are additionally shown in large size on the displays to make them convenient and readily viewable.

The function keys are assigned to a variety of airplane systems such as the radio, transponder, GPS or variometer. The indicators assigned to the individual function keys show predetermined associated values such as the radio frequency, transponder code, GPS-receiving quality, or a variometer-MC ready value. A particularly convenient and easily viewed arrangement is when the function keys are on a bar that is preferably located above the displays and the indicators are positioned immediately adjacent to each other and preferably above or below the function keys.

Some function keys can be tiltable in several directions so that, for example, urging the key in one direction activates a function and shows a reference value on the indicator. Urging the function key in a perpendicular direction feeds the reference value with its associated variables to a desired value presetting bar.

The space available in the cockpit of light airplanes is optimally used when the function key bar and the bar holding the associated indicators are arcuate and preferably arranged above the displays. It is useful if at least selected portions of the displays, and preferably the entire display, have an arcuate contour.

As already mentioned, certain systems, particularly the altimeter and air speed instruments which reflect flight movement, must operate continuously since it must at all times be possible to read them. In accordance with the present invention, such instruments, which are preferably conventional instruments, are positioned laterally of the displays and/or function keys on the instrument panel.

It is further advantageous to provide several displays on the instrument panel. One display can, for example, be used for variably displaying information relating to whichever function key is activated. Another display can carry GPS information. Finally, an additional available display element can be provided, for example, for controlling and managing engine operation.

In accordance with the invention, the instrument panel additionally has input and/or adjustment means, preferably in the form of switches, keys and/or rotary knobs for activating or regulating certain systems, adjusting the volume of acoustic indicators, and the like. In this manner, the magnitude of a primary reference value can be changed and fixed, preferably by pressing the desired value presetting bar. The resulting uniform use and control of all functions helps minimize pilot distractions in the cockpit.

To facilitate conforming the cockpit in a simple manner to the various requirements and other aspects of the invention, the navigational instruments, that is, the instrumentation groups on the instrument panel, can be made as modules which are individually installable in the instrument panel.

### BRIEF DESCRIPTION OF THE DRAWINGS

The single drawing shows an exemplary embodiment of the present invention and is a plan view of the arrangement of a cockpit for light airplanes in accordance with the invention.

### DESCRIPTION OF THE PREFERRED EMBODIMENTS

A cockpit made in accordance with the invention has an instrument panel 1 which, in the illustrated embodiment, has three displays 2, 3 and 4. Above display 2 is a bar 5 with function keys 6. Indicators 7 are associated with function keys 6. Bar 5, function keys 6 and indicators 7 are arcuate and arranged above display 2. On both sides of display 2 are the usual instruments for controlling flight movements, namely altimeter 8 and flight instrumentation such as an air speed indicator 9.

Instrument panel 1 further has switches, keys and rotary knobs 11, 12. The keys or rotary knobs can, for example, be used for changing and fixing reference values for the functions on an associated presetting bar 13 preferably located between displays 2 and 3. A switch 10 is provided for activating the entire system. Control knobs 14 are further provided for changing the volume of acoustic systems such as acoustic variometers, acoustic flight information or the radio and are positioned to the side of the row of function keys.

By activating the function keys, associated information is shown on the displays while predetermined values for the activated system are shown on the associated indicators 7. Thus, display 2 shows in large letters or symbols certain information and instructions, such as directional information, preset information, flight requirements, or climbing information. Display 3 receives GPS information and in particular provides positional ground and air space information as well as other conventional parameters. Display 4, which can be deleted if not needed, can be used for controlling other systems such as engine operation and control. In addition, the space not needed by this system can be used for circuit breakers and the like.

Bar 5, function key 6 and indicators 7, as well as displays 2, 3 and 4, and switches, keys and rotary knobs 10, 11 and 12, can be made as modules so that they can be individually installed on instrument panel 1. This enables adaption and variation of the instrument panel to the encountered requirements.

What is claimed is:

1. Cockpit for light airplanes comprising an instrument panel (1), navigational instruments arranged on the instrument panel, at least one display (2), (3), (4), a plurality of function keys for showing desired information on the display, and indicators associated with the function keys (6), the display, the functions keys and the indicators having an outer boundary that is arcuate along at least one side.

2. Cockpit according to claim 1 including a bar (5) arranged above the displays, and wherein the function keys are mounted on the bar.

3. Cockpit according to claim 1 wherein each indicator is positioned immediately adjacent the associated function key (6) and is located immediately above or immediately below the associated function key (6).

4. Cockpit according to claim 1 wherein at least one function key (6) is tiltable in different directions.

5. Cockpit according to claim 1 including a bar, wherein the function keys are mounted on the bar, and wherein the bar and the associated indicators (7) are arcuately arranged.

6. Cockpit according to claim 1 wherein one of at least a portion of the display and the entire display have an arcuate contour.

7. Cockpit according to claim 1 including an altimeter (8) and an air speed indicator (9) arranged on the instrument panel (1) lateral of display (2) and function keys (6).

8. Cockpit according to claim 1 including a plurality of displays (2), (3), (4) arranged on the instrument panel (1).

9. Cockpit according to claim 1 including input and/or adjustment means comprising at least one of switches, keys and rotary knobs (10), (11), (12) arranged on the instrument panel (1).

10. Cockpit according to claim 1 including a desired value presetting bar for displaying functional reference values and arranged between two displays (2), (3).

11. Cockpit according to claim 1 including at least one of a combination rotary-/pressure-sensitive key (11) and a two-axis key (12) for changing the desired values of all variables.

12. Cockpit according to claim 1 wherein the navigational instruments comprise instrument modules adapted to be individually installed on the instrument panel (1).
